(19) United States
(12) Patent Application Publication
(10) Pub. No.: US 2005/0271209 A1
(43) Pub. Date: Dec. 8, 2005

(54) AKA sequence number for replay protection in EAP-AKA authentication

(76) Inventors: Meghana Sahasrabudhe, San Jose, CA (US); Henry Haverinen, Jyvaskyla (FI); Ming Shou Gung, Plano, TX (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/145,163

(22) Filed: Jun. 6, 2005

Related U.S. Application Data
(60) Provisional application No. 60/577,194, filed on Jun. 7, 2004.

(51) Int. Cl. H04K 1/00

(52) U.S. Cl. 380/270

(57) ABSTRACT

A method of providing authentication in a wireless network including sending, from a terminal to a wireless network a request for access authorization. The method includes transmitting from a server a return message. The return message is composed using a default sequence number value. The method includes initiating a resynchronization procedure based on receipt of the return message by the terminal and storing a sequence number in the terminal and in the server; and sending from the server, an authentication continuation message to the terminal.

### REFERENCE TO RELATED APPLICATIONS

This application claims benefit under 35 U.S.C §119(e) of provisional application No. 60/577,194, filed on Jun. 7, 2004 the contents of which is hereby incorporated by reference.

### BACKGROUND OF THE INVENTION

1. Field of Technology

The invention is in the field of access authentication in a cellular network.

2. Description of the Related Art

As an example, in a cellular-WLAN interworking model, a code division multiple access (e.g., cdma2000) based core network authenticates and authorizes a certain terminal that wants to use the WLAN and/or cellular network based services, service provider services, Internet services, etc. The terminal can be a laptop computer, a mobile station (with or without the use a smart card), a Personal Digital Assistant (PDA), etc.

Authentication allows each party to a communication to trust that the other party is who it purports to be. A set of protocols, procedures, and associated agreements that allow communicating entities to exchange credentials and share keys for digital signatures and encryption provides a trust infrastructure. A trust infrastructure may rely on some information being provided “out-of-band”, e.g., transactions not susceptible to eavesdropping. The out-of-band information is typically a (public) key or keys associated with the identity of its owner.

Extensible Authentication Protocol—Authentication Key Agreement (EAP-AKA) is an authentication scheme that can be used to authenticate a cellular terminal, a WLAN terminal or a cellular/WLAN dual-mode terminal, with or without the use of a smart card, to a core network such as the cdma2000 core network operating in the cellular-WLAN interworking environment.

One of the requirements of any authentication schemes is the ability to provide replay protection. Replay protection guards against data being captured and then re-injected into the communication path after the data has been compromised.

EAP-AKA was not designed as an authentication mechanism to be used with symmetric keys and has to provide some means of replay protection. One of the ways replay protection is accomplished in EAP-AKA is if the terminal and the network both store information about the used and unused ranges of an AKA sequence number. If both have a consistent and synchronized copy of the AKA sequence number information, replay protection is provided by making sure that the sequence number used in an AKA protocol exchange has not been previously used in an earlier AKA protocol exchange. The exact usage of the sequence number has not been normatively specified. An easy way to guarantee that a fresh number is used would be to use the sequence numbers incrementally, so that both the terminal and the server only need to store the highest sequence number used so far. The server can then generate a fresh sequence number simply by incrementing its copy of the highest previously used sequence number by one. However, the problem is that this way of replay protection requires storing the AKA sequence number in some persistent state in the network on a central entity. For example, when a terminal is trying to authenticate to a server, the server is required to obtain a copy of the latest sequence number from this central entity. This requires inefficient use of the network's resources. This stems from the desire that the network should not have to store the sequence number in some persistent state and each new authentication server then does not have to retrieve this sequence number from this persistent state when the terminal wishes to perform authentication with this authentication server.

FIG. 1 is a diagram that illustrates the full authentication procedure for EAP-AKA. The authenticator typically communicates with an EAP server that is located on a backend authentication server using an Authentication, Authorization, and Accounting (AAA) protocol. The authenticator server is often simply relaying EAP messages to and from the EAP server. These back end AAA communications are not shown. At the minimum, EAP-AKA uses two roundtrips to authorize the user and generate session keys. As in other EAP schemes, an identity request/response message pair is usually exchanged first. On full authentication, the user's identity response includes either the user's International Mobile Subscriber Identity (IMSI), or a temporary identity (pseudonym) if identity privacy is in effect.

After obtaining the subscriber identity, the EAP server obtains an authentication vector AV, for use in authenticating the subscriber. The AV is a concatenation of several parts including a random number part (RAND), an authentication token part (AUTN), an expected result part (XRES), a session key for encryption (CK), and a session key for integrity check (IK). From the vector, the EAP server derives the keying material. The vector may be obtained by contacting an Authentication Centre (AuC) on the UMTS network, per UMTS specifications. Several vectors may be obtained at a time. Vectors may be stored in the EAP server for use at a later time, but they may not be reused.

Further, the AUTN is itself a concatenation of several fields including a sequence number (SQN) that is logically added using the exclusive or (XOR) operator to an anonymity key (AK), which is derived from a secret key K; an authentication and key management field AMF to allow handling of multiple authentication algorithms and keys, changing sequence number verification parameter sets and setting threshold values to restrict the lifetime of cipher keys CK and integrity keys IK; and a message authentication code MAC. The anonymity key AK is used to hide to the sequence number SQN from wireless eavesdroppers. Its use is optional, and the operator may choose to use an all-zero anonymity key AK, in which case the sequence number SQN is included “as-is” in the AUTN parameter.

Next, the EAP server starts the actual AKA protocol by sending an EAP-Request/AKA-Challenge message. EAP-AKA packets encapsulate parameters in attributes, encoded in a Type, Length, Value format. In the EAP-AKA specification, the attributes are denoted with names that begin with “AT_”. The EAP-Request/AKA-Challenge message contains a RAND random number (in the AT_RAND attribute) and a network authentication token (AT_AUTN), and a message authentication code (AT_MAC). The AT_MAC attribute contains a message authentication code covering the EAP packet. The terminal runs an AKA algorithm and verifies the AUTN. To verify the AUTN, upon receipt of RAND and AUTN the terminal first computes the anonymity key AK=f5.sub.K (RAND) and retrieves the sequence number SQN=SQN.sym.AK).sym.AK. Next, the terminal computes XMAC=f1.sub.K(SQN.parallel.RAND.parallel.AMF) and compares this with MAC. If they are different, the terminal send a user authorization reject back to the server with an indication of the cause for the failure and abandons the procedure.

Next, the terminal verifies that the received sequence number SQN is within the correct range, in order to verify that the authentication vector is “fresh”, or previously unused. As explained above, the server maintains the fresh sequence number range for each subscriber across authentication exchanges, and the terminal verifies that each authentication vector has a previously unused sequence number. If the terminal determines that the SQN is not in the correct range, for example because the SQN is smaller than the greatest number used so far, the terminal sends a synchronization failure back to the authentication server. In this case, a resynchronization procedure is started when, the terminal calculates a sequence number synchronization parameter AUTS and sends it to the authentication server, in order to tell the server what the expected range of the sequence number SQN currently is. Authentication may then be retried with a new authentication vector generated using the synchronized sequence number SQN. Resynchronization has been included in the UMTS mechanism originally in order to facilitate authentication vector AV caching. A network element may fetch several authentication vectors in advance, so that it can re-authenticate the terminal more efficiently. Since several network elements in the UMTS network can cache authentication vectors, it is possible that the vectors are not always consumed in the correct order. Therefore, a synchronization procedure is required in order to allow the terminal to indicate to the server that the server needs to obtain fresh authentication vectors instead of the cached vectors.

If the SQN is verified, the terminal is verified to be talking to a legitimate EAP server and proceeds to send the EAP-Response/AKA-Challenge. This message contains a result parameter that allows the EAP server in turn to authenticate the terminal, and the AT_MAC attribute to integrity protect the EAP message. The EAP server verifies that the RES and the MAC in the EAP-Response/AKA-Challenge packet are correct. Because protected success indications are not used in this example, the EAP server sends the EAP-Success packet, indicating that the authentication was successful. The EAP server may also include derived keying material in the message it sends to the authenticator. The terminal has derived the same keying material, so the authenticator does not forward the keying material to the peer along with EAP-Success.

There are other schemes proposed however for reply protection like embedding nonces in the user's permanent username. However, these proposed schemes seem more like a hack to the authentication procedure and changes the semantics of the current EAP-AKA specification.

### SUMMARY OF THE INVENTION

An exemplary embodiment of the invention is a method of providing authentication in a wireless network. According to this embodiment, the method includes sending, from a terminal to a wireless network a request for access authorization. The method includes transmitting from a server a return message, wherein the return message includes the authentication token AUTN parameter, composed using a “default” sequence number SQN. The default sequence number value is chosen, specifically to the local usage of the SQN, so that it is certainly going to be not fresh. If the sequence numbers SQN are used incrementally, then a very small SQN value can be used. The method includes initiating a resynchronization procedure based on receipt of the return message by the terminal and storing a sequence number in the terminal and in the server.

Another exemplary embodiment of the invention includes an apparatus for providing authentication in a wireless network. According to this embodiment, the apparatus includes a terminal transmitting means for sending, from a terminal to a wireless network, a request for access authorization. The apparatus further includes a server transmitting means for transmitting from a server, a return message, wherein the return message is composed using a “default” sequence number value. The apparatus further includes a resynchronization means for initiating a resynchronization procedure, wherein the initiation is based on receipt of the return message by the terminal and a terminal storage means for storing a sequence number, wherein in the apparatus, authentication is continued after the resynchronization procedure is completed.

Another embodiment of the invention includes a system for providing authentication in a wireless network, the system including a wireless local area network (WLAN) access network. The system includes a terminal connected to the wireless area network (WLAN), wherein the terminal requests access to the wireless network; and a cellular network connected to the wireless area network (WLAN), wherein the cellular network includes at an authentication server, wherein in the system, the terminal requests access authorization from the cellular network. Further in the system, the authentication server transmits a return message to the terminal in response to the request, wherein the request is composed using a “default” sequence number value, and the terminal initiates a resynchronization procedure in response to the return message and stores a sequence number.

### BRIEF DESCRIPTION OF THE FIGURES

FIG. 1 is a diagram that illustrates the full authentication procedure for EAP-AKA;

FIG. 2 illustrates a Cellular network-WLAN interworking access authentication model; and

FIGS. 3A and 3B illustrate a message flow according to an exemplary embodiment of the present invention.

### DETAILED DESCRIPTION OF THE PREFERRED EMBODIMENT(S)

The present invention addresses the need for replay protection in any authentication scheme for the cellular-WLAN interworking model as illustrated in several exemplary embodiments. For illustration purposes, the WLAN is used as an example of wireless access network while the cdma2000 core network is used as an example of cellular core network. The invention described herein can be applicable to similar wireless networks based on various air interface technologies.

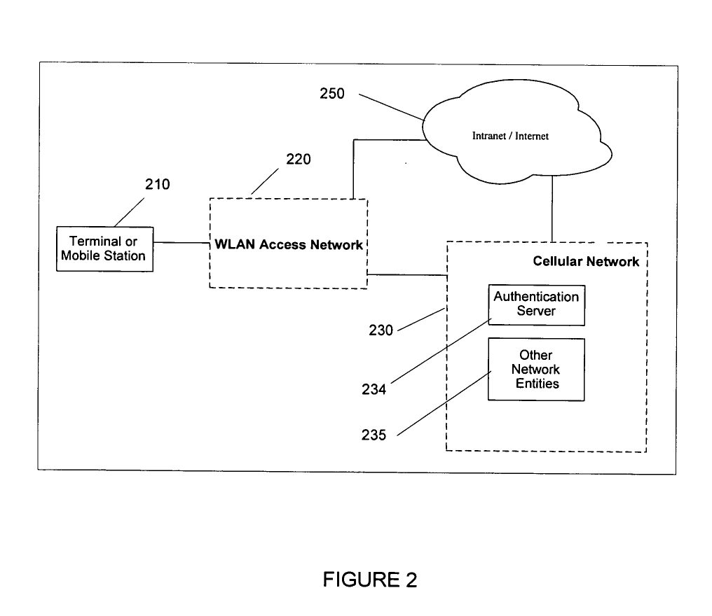

The present invention can be implemented in an exemplary system illustrated in FIG. 2. A terminal 210 that connects to a WLAN access network 220 that interworks with a cellular network 230, for example a cdma 2000 core network, needs to become authenticated by the cdma2000 core network 230. The cellular network 230 includes an authentication server 234 and other network entities 235 that are known to those skilled in the art, for example, an EAP server. As discussed above, EAP-AKA is one authentication mechanism that is used to authenticate a WLAN terminal 210 to the cellular network 230.

Any authentication scheme used in the system illustrated in FIG. 2, requires provisions for replay protection. For example, in the EAP-AKA authentication scheme described above, replay protection is achieved through a use of the sequence number SQN. In the typical implementation, the sequence number SQN is incremented each time authentication is performed by the terminal. However, this authentication scheme requires that both the terminal and the network keep a synchronized copy of the sequence number in order to provide replay protection. It is difficult and an inefficient use of resources to provision the network to save a current copy of the sequence number during the authentication process.

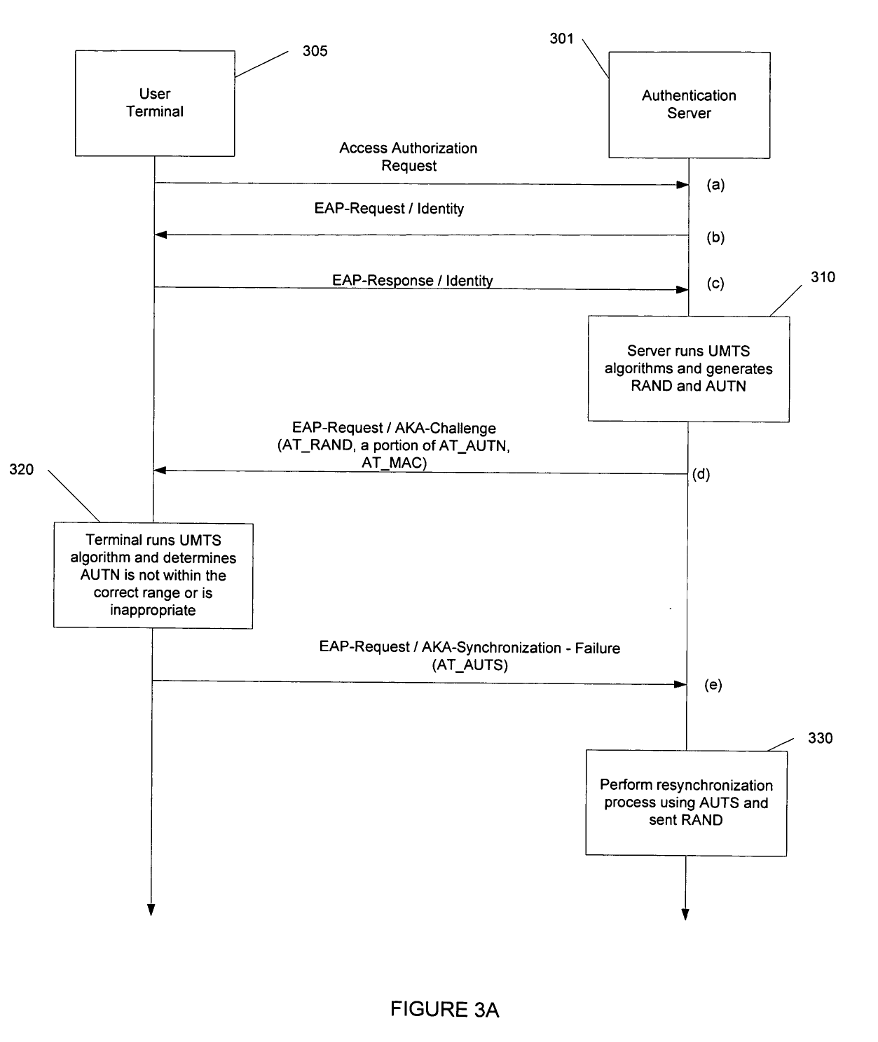

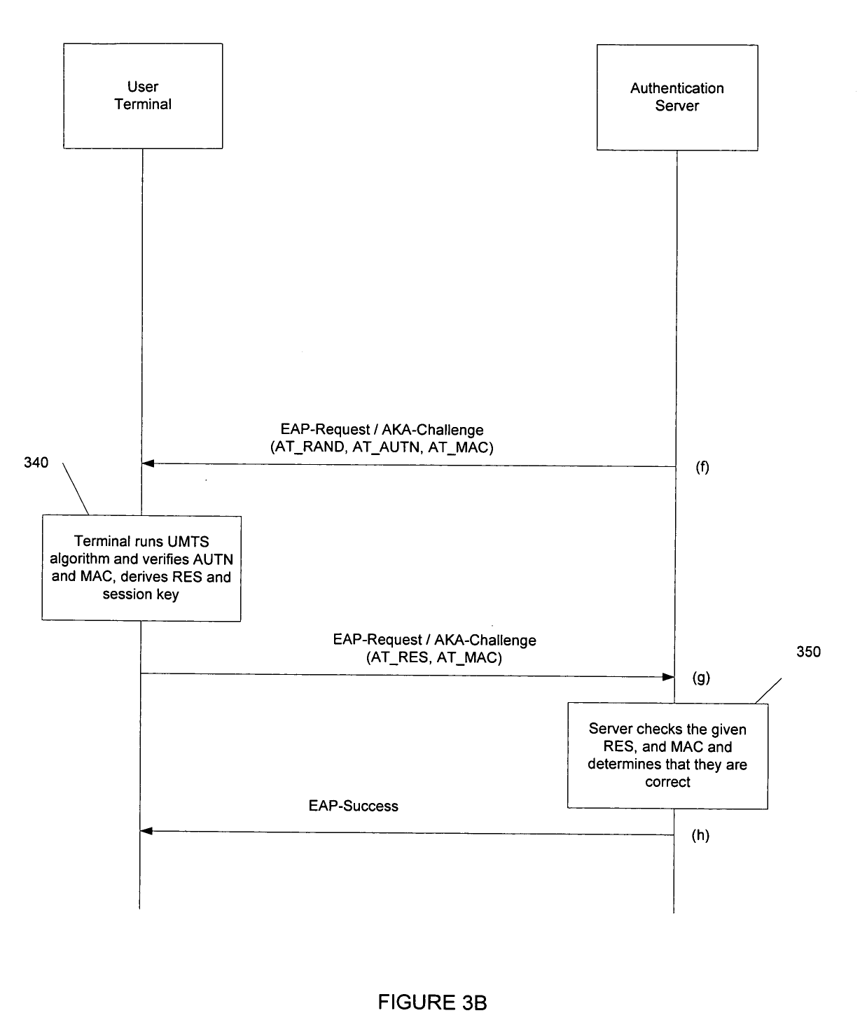

According to an exemplary embodiment, the present invention stores the sequence number only on the user terminal, and provides replay protection. This is achieved during authentication as illustrated in the diagram of FIGS. 3A and 3B.

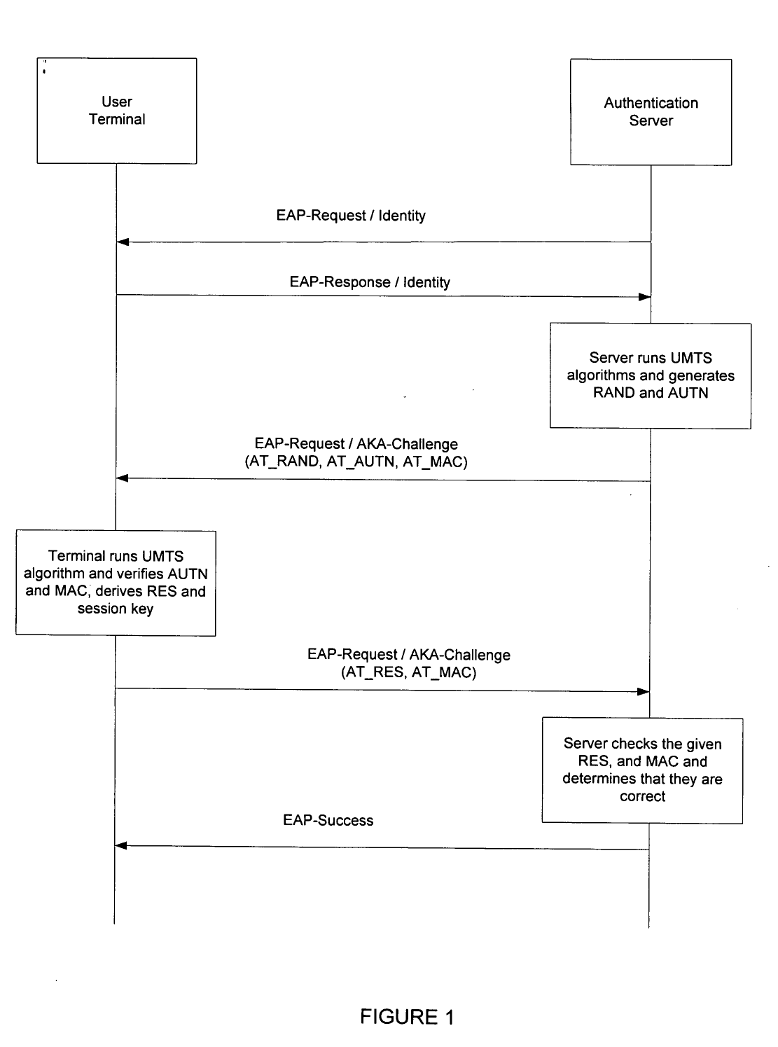

FIGS. 3A and 3B illustrate an exemplary embodiment of the present invention. The process begins when a user terminal 305 indicates the need for authentication to the authentication server 301 (a). The server transmits an identity request message (b) and receives a return message (c). The server 301 runs UMTS algorithms and generates RAND and AUTN in reply to the need for authentication 310. When generating the UMTS authentication token value AUTN according to the present invention, the server 301 does not need to have a synchronized copy of the sequence number SQN, but the server 301 may use a “default” sequence number SQN, which is known to not belong in the correct range of fresh sequence numbers. For instance, a very small SQN value may be used. The authentication server sends a return message (d) that includes AT_RAND, AT_MAC and AT_AUTN. The reception of the SQN portion of AUTN value included in the AT_AUTN attribute 320 triggers a resynchronization procedure, as discussed above, because terminal 305 determines that the sequence number is out of range. In the resynchronization procedure the terminal 305 calculates a sequence number synchronization parameter AUTS, according to the usual UMTS AKA procedure. The resynchronization procedure 330 starts when the terminal 305 sends back an AKA Synchronization Failure message along with the attribute AT_AUTS, which contains the AUTS value, to force the authentication server 301 to use the correct sequence number (e). As illustrated in FIG. 3B, the failure message (e) prompts the server to store the sequence number and to send a new AKA Challenge message to the terminal to continue with the authentication as shown in steps (f)-(h), which are the same as shown in FIG. 1.

For subsequent authentications, the server may save a temporary copy of the sequence number. This copy of the sequence number will time out and is no longer stored in the server, when the terminal moves away or shuts down and no longer performs authentication with this server. The terminal stores the sequence number in persistent state using various means known in the art.

Some advantages of the present invention are that only the terminal needs to store a copy of the sequence number for replay protection and the network is not required to do so. This saves the network from having to maintain a persistent state associated with this sequence number at some central entity and also eliminates the need of the authentication servers to get an updated copy of this sequence number from the central entity.

One having ordinary skill in the art will readily understand that the invention as discussed above may be practiced with steps in a different order, and/or with hardware elements in configurations which are different than those which are disclosed. For example, the present invention may be implemented at least as a computer product including computer-readable code, a chip set or ASIC, or a processor configured to implement the method or system. Therefore, although the invention has been described based upon these preferred embodiments, it would be apparent to those of skill in the art that certain modifications, variations, and alternative constructions would be apparent, while remaining within the spirit and scope of the invention. In addition, the present invention is related to the 3GPP2. It specifically relates to WLAN Interworking standardization for 3GPP2 packet data networks, and could also be used in 3GPP networks.

1. A method of providing authentication in a wireless network, the method comprising:
sending, from a terminal to a wireless network, a request for access authorization;
transmitting a return message, the return message comprising a default sequence number value;
initiating a sequence number resynchronization procedure based on receipt of the return message;
storing a sequence number; and
sending, from a server, an authentication continuation message to the terminal.

2. The method of claim 1, wherein the initiating of the resynchronization procedure comprises transmitting a synchronization failure message from the terminal, wherein the synchronization failure message is based on receipt of the portion of the default sequence number value.

3. The method of claim 1, wherein in the transmitting from the server the return message, the return message intentionally includes only a portion of the default sequence number value.

4. The method of claim 1, wherein in the transmitting from the server the return message, the default sequence number value is an authentication token parameter.

5. The method of claim 2, wherein in the initiating of the resynchronization procedure, the synchronization failure message is an authentication key agreement synchronization failure message, and the sequence parameter included with the synchronization failure message is an AT_AUTS parameter.

6. The method of claim 1, wherein storing a copy of the sequence number includes storing the copy of the sequence number in a persistent state in the terminal.

7. The method of claim 6, wherein storing a copy of the sequence number further includes temporarily storing the sequence number in the server and later deleting the sequence number from the server when the sequence number expires.

8. An apparatus for providing authentication in a wireless network, the apparatus comprising:
a terminal transmitting means for sending, from a terminal to a wireless network, a request for access authorization;
a server transmitting means for transmitting from a server a return message including only a portion of a default sequence number value;
a resynchronization means for initiating a resynchronization procedure, wherein the initiation is based on receipt of the return message by the terminal; and
a terminal storage means for storing a sequence number, wherein the authentication is continued after the resynchronization procedure is completed.

9. The apparatus of claim 8, wherein the resynchronization means comprises a transmitting means for transmitting a synchronization failure message from the terminal, wherein the synchronization failure message is based on receipt of the portion of the default sequence number value and the synchronization failure message includes a sequence parameter.

10. The apparatus of claim 8, wherein the server transmitting means transmits a return message that intentionally includes only a portion of the default sequence number value.

11. The apparatus of claim 8, wherein the default sequence number value transmitted by the server transmitting means is an authentication token parameter.

12. The apparatus of claim 9, wherein in the resynchronization means, the synchronization failure message is an authentication key agreement synchronization failure message, and the sequence parameter provided with the synchronization failure message is the AT_AUTS parameter.

13. The apparatus of claim 8, wherein the terminal storage means stores a copy of the sequence number in a persistent state and the server stores the copy of the sequence number temporarily until the sequence number expires.

14. A system for providing authentication in a wireless network, the system including a wireless local area network (WLAN) access network, the system comprising:
a terminal connected to the wireless area network (WLAN), wherein the terminal requests access to the wireless network; and
a cellular network connected to the wireless area network (WLAN), wherein the cellular network includes at an authentication server,
wherein the terminal requests access authorization from the cellular network, and
the authentication server transmits a return message to the terminal in response to the request, wherein the request includes a portion of default sequence number value, and the terminal initiates a resynchronization procedure in response to the return message and stores a sequence number.

15. The system of claim 14, wherein the terminal transmits a synchronization failure message, wherein the synchronization failure message is based on receipt of the portion of the default sequence number value from the authentication server and the synchronization failure message includes a sequence parameter.

16. The system of claim 14, wherein the authentication server intentionally transmits only a portion of the default sequence number value to the terminal.

17. The system of claim 14, wherein the sequence number is stored in the terminal in a persistent state and is stored in the authentication server temporarily until the sequence number expires.

18. A computer program embedded on a computer-readable medium, for providing authentication in a wireless network, comprising the method of claim 1.

19. An authentication server for providing authentication in a wireless network, the authentication server comprising:
a receiver means that receives a request for access authorization from a terminal;
a server transmitting means that transmits to the terminal, a return message including only a portion of a default sequence number value; and
a storage means that stores a copy of a sequence number.

20. The authentication server according to claim 19, wherein the return message including only a portion of a default sequence number value, initiates a resynchronization procedure in the wireless network.

21. The authentication server according to claim 19, wherein the storage means stores the copy of the sequence number temporarily until the sequence number expires.
